(19) United States
(12) Patent Application Publication
(10) Pub. No.: US 2014/0070548 A1
(43) Pub. Date: Mar. 13, 2014

(54) Lockable handle/grip system with coupling for sliding windows

(71) Applicant: Bulgan Soner, Adana (TR)

(72) Inventor: Bulgan Soner, Adana (TR)

(73) Assignee: BULGAN INSAAT SANAYI VE TICARET LIMITED SIRKETI, Adana (TR)

(21) Appl. No.: 13/131,866

(22) PCT Filed: Mar. 9, 2010
(86) PCT No.: PCT/TR2010/000041

§ 371 Date: Dec. 2, 2012

(30) Foreign Application Priority Data
Mar. 11, 2009 (TR) 2009/01913

(51) Int. Cl. E05C 1/10

(52) U.S. Cl. CPC E05C 1/10
USPC 292/175

(57) ABSTRACT

The invention subject product is related with a window lock with a low cost, high safety grip system with a sliding coupling reducing the entrance of natural effects like air, dust and rain water, which may come from outside, to a minimum. Said lock consists from eight main parts composed from a stick-grip (1a), grooved tube (1b), a lock shaft with an adjusted screw (2a), shaft head of the lock shaft with adjusted screw (2b), slot cover (3), adjustment fixation nut (4), lock shaft pulling spring (5), shaft-spring spring and nut slot (6), lock head nut (7) and pulling lock head (8). The locking system is located between both grips and is connected to the sliding system from a single point. In the practice no counter-parts are used, which are affixed on the case.

The invention involves a handle/grip system with coupling used for sliding windows.

Opening/closing apparatuses and locks fulfilling the locking and closing function at windows involve an important functions both in respect of security and heat insulation and for the protection against natural effects i.e. rain, dusts which may come from outside. Many handle/grip and lock systems are developed purposing the fulfillment of these objects.

In the present system, sliding espagnolettes in accordance with the length of the slide are affixed to the part of both sliding wings of the sliding window matching to case. On the wings a grip place is opened in a manner that the sliding espagnolettes are matching on the case and the grip is assembled. On the sliding case zamak (metal alloy) counter-parts are connected in a manner matching the coupling part of the espagnolettes and in sufficient number. The sliding wings are hold from the part where the grips are located and dragged in both directions to the part where the case is located. Locking process is made by turning the grips with an angle of 90 degree. Opening is ensured by turning the grips with an angle of 90 degree in adverse direction.

In existing systems there are some difficulties. These difficulties may be indicated as follows:

In cases where the sliding wings are closed, the points where the sliding clamps are unified are letting under various weather conditions air inside the interior atmosphere and thus also dust and rain water.

The counter adjustments are getting frequently defect depending on atmosphere conditions.

Sine the grips affixed on both sliding wings (in case that no hidden pool grips are affixed) will prevent the over-crossing of the windows, this causes that the sliding window on the internal side can not be wiped.

The assembling of existing systems requires a labor power of approx 25-30 minutes, resulting both in loss of labor power and increasing of costs.

Existing systems involve significant security lacks like easy opening with a simple intervention from outside.

Connected counter-parts are rubbing against the bristle filters placed on the sliding wing and results in difficulties to move the wing.

The zamak (metal alloy) counter-parts are worn out and get broken within time depending on the utilization and thus they require quite frequent maintenance and repair costs.

The advantages of the system developed purposing the elimination of above mentioned difficulties are as follows;

Since the locking grip mechanism is located in the center of both wings, the entrance of air and thus dust and rain waters into the internal atmosphere are prevented by the fact that the wings are pulled to each other during the locking process. Since the grip will be connected in the sliding system at one point, the moving ability of both sliding wing will not be restricted when the system is in open position, thus both windows on the sliding wings can be easily cleaned (with quite low costs).

Since the grip and counter-part is located in the sliding system at one point, the counter-part adjustments are not changed unexpected and thus the function of the system for a long term without any difficulty is ensured and according the maintenance/repair costs of the system are reduced to a minimum.

Since there are no counter-parts assembled on the case, the bristle filters on the sliding wings have no contact at any point and according the facile function of the system is ensured.

The application of a locking system with a sliding coupling allows the deployment of one person with a labor power of just 5 minutes, and this ensures an economical contribution by reducing the labor cost.

A window closed using such a locking system provides a high security despite to any possible intervention from outside.

The invention developed purposing to reach above mentioned objects is shown in enclosed figures, and these figures are reflecting following:

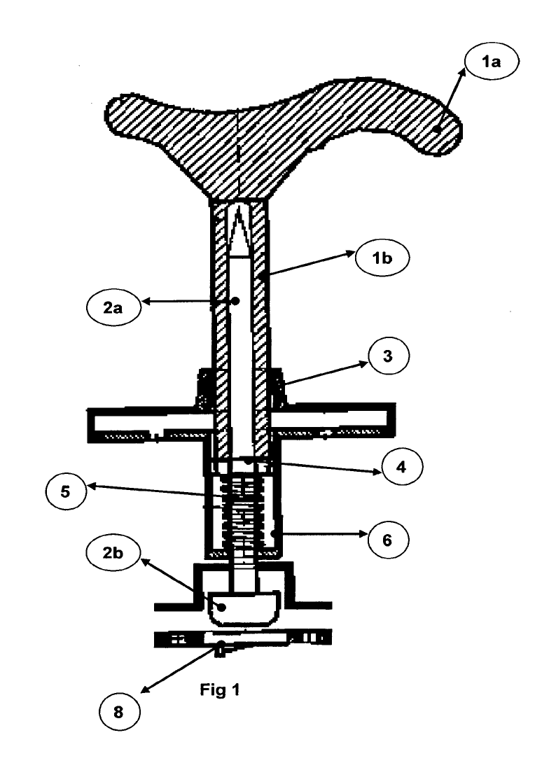

FIG. 1: General cross-section view of the lock with sliding coupling.

FIG. 2: View of a burst-opened sliding coupling lock.

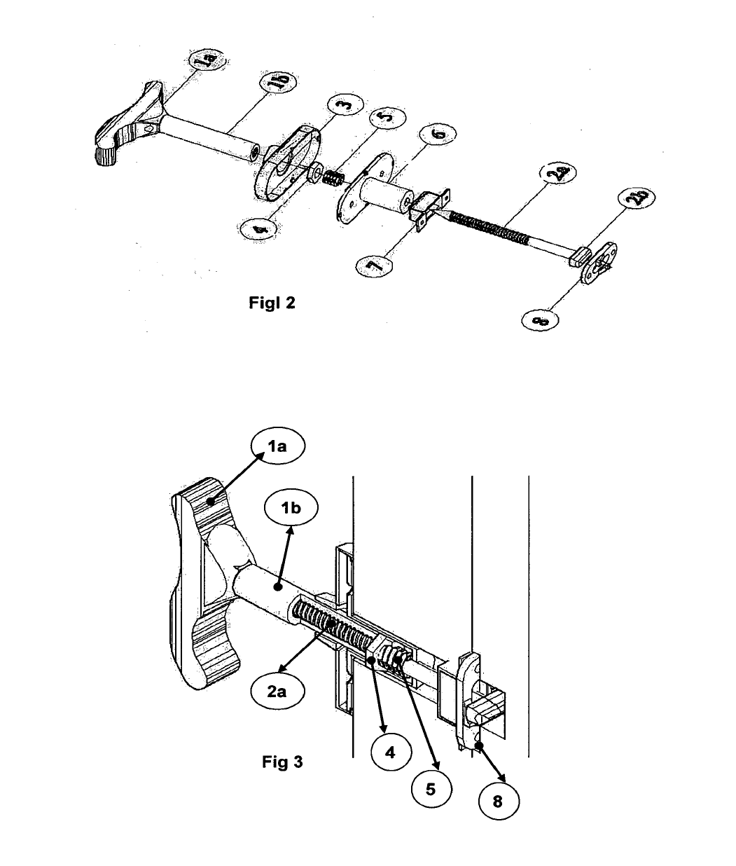

FIG. 3: Cross-section view of a sliding coupling lock in assembled position.

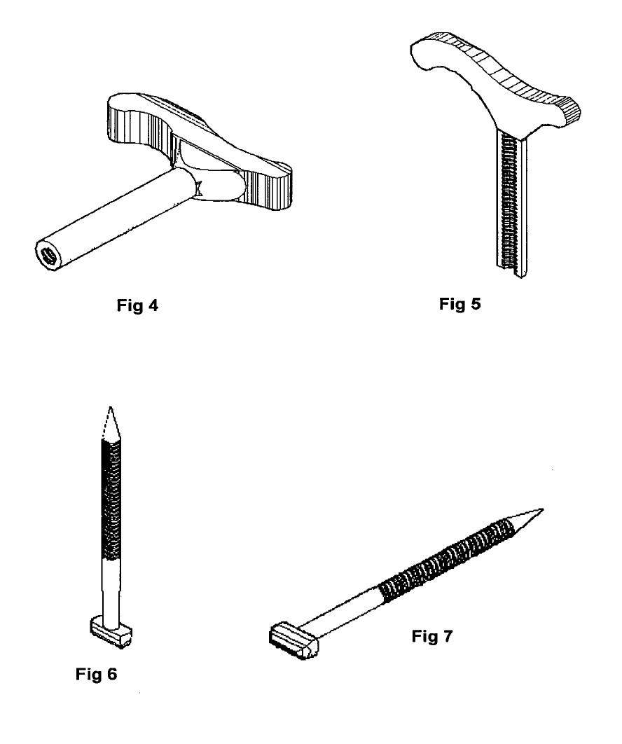

FIG. 4: General view of the stick-grip.

FIG. 5: Cut-off view of the stick-grip.

FIG. 6: Vertical view of the grooved tube.

FIG. 7: Horizontal view of the grooved tube.

FIG. 8: General view of the slot cover.

FIG. 9: Cut-off view of the slot cover.

FIG. 10: General view of the adjustment fixation nut.

FIG. 11: Cut-off view of the adjustment fixation nut.

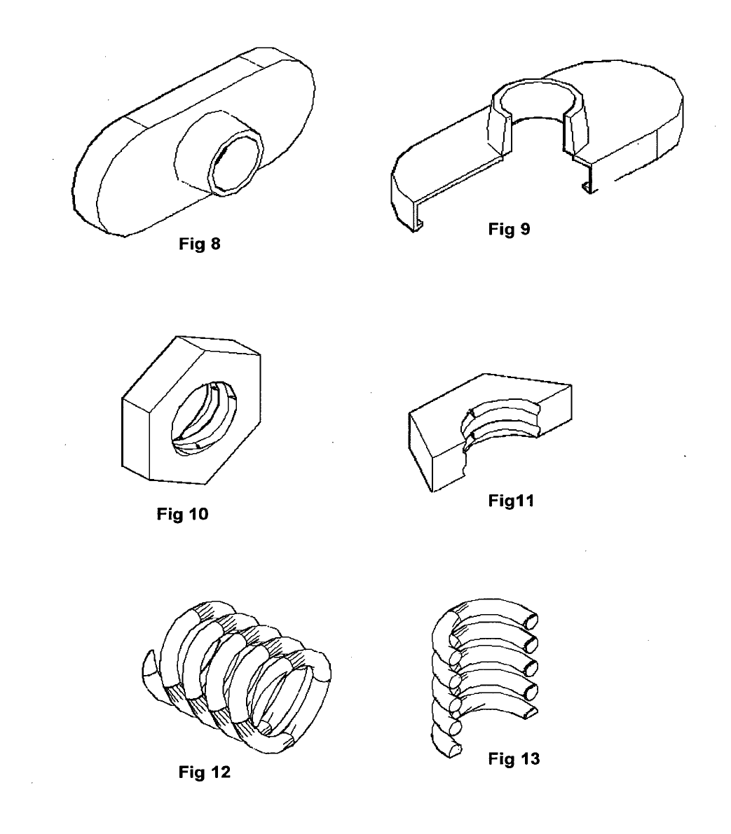

FIG. 12: General view of the lock pulling spring.

FIG. 13: Cut-off view of the lock pulling spring.

FIG. 14: Cut-off view of the shaft, spring and nut slot.

FIG. 15: General view of the shaft, spring and nut slot.

FIG. 16: General view of the lock stop.

FIG. 17: Cut-off view of the lock stop.

FIG. 18: General view of the pull-able lock counter-part.

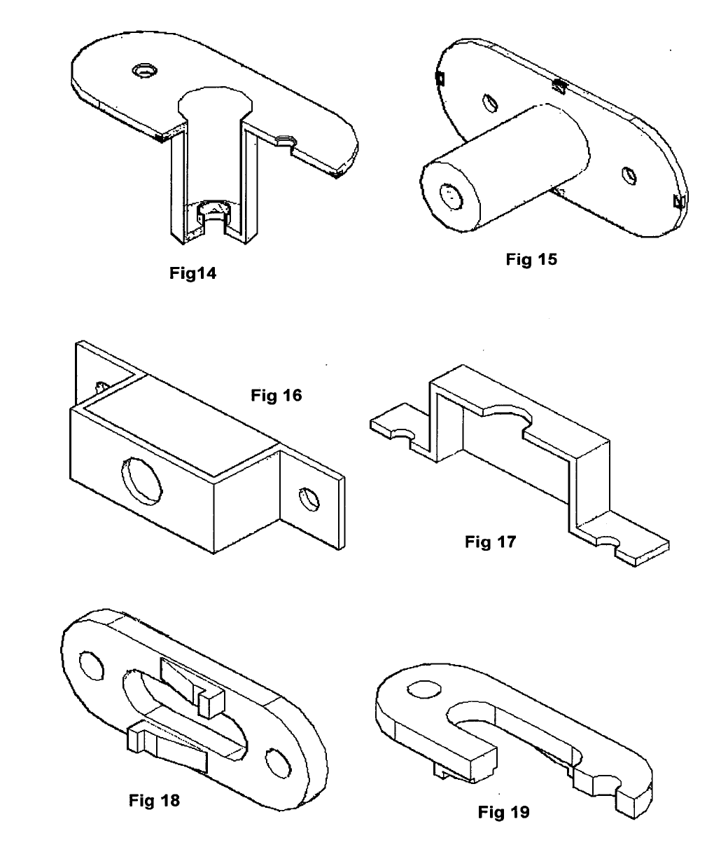

FIG. 19: Cut-off view of the pull-able lock counter-part.

The parts shown on the figures are one-by-one numbered, and the relevant numbers are given below:
1a—Stick-grip
1b—Grooved tube
2a—Lock shaft with adjusted screw
2b—Lock shaft head with adjusted screw
3—Slot cover
4—Adjustment fixation nut
5—Lock shaft pulling spring
6—Shaft, spring and nut slot
7—Lock head stopper
8—Pull-able lock counter-part

The invention subject product is basically composed from 8 main parts as follows: a stick grip (1a) located at the very external side; a grooved tube (1b), which is located beneath the stick grip (1a) and includes the lock shaft with adjusted screw (2a), since the inside is grooved, and ensures the utilization of the product inside the sliding system with different wide; lock shaft with adjusted screw (2a), which ensures the adjustment through the sets thereon by entering inside the lock shaft; head of lock shaft (2b), which enters inside the counter-part of the pulling lock (8) and makes the locking when turned; adjustment fixation nut (4), lock shaft pulling spring (5) and slot cover (3) covering the shaft-spring and nut slot (6); adjustment fixation nut (4), which acts as fixing element during unification of the lock shaft with adjusted screw (2a) and grooved tube (1b) and holds the lock shaft pulling spring (5); adjustment fixation nut (4) and lock shaft pulling spring, which allows to pull back the lock shaft with adjusted screw (2a) by means of the and shaft, spring and nut slot (6); shaft-spring and nut slot (6), which allows the lock shaft pulling spring (5) to fulfill its duty and assembled to the slot cover (3); lock head stopper (7), which ensures that the lock shaft with adjusted screw and its head (2a and 2b) stay as back as the sliding wing and pulling lock counter-part (8) which includes the head of the lock shaft with adjusted screw and assists the locking by being turned.

The parts constituting the grip with sliding coupling are assembled as follows:

The head of the lock shaft with adjusted screw (2b) is put through the lock head stopper (7). Afterwards the shaft-spring is fitted into the nut slot (6). The lock nut pulling screw (5) is attached to the head of the lock shaft with adjusted screw (2b);

the adjustment fixation nut (4) is attached to the lock shaft with adjusted screw (2a). Then the slot cover (3) is inserted through the lock shaft with adjusted screw (2a) and attached to the stick grip (1a). Thus the grip with sliding coupling, which parts are fixed to each other in this manner becomes ready to be assembled.

Assembling of the grip with sliding coupling:

A section is opened in the part unified in the center by sliding the two moving sliding wings to the right and left, sufficient to insert the shaft-spring and nut slot (6). The lock head stopper (7) is assembled to the internal part of the wing left in the front section. In the from section of the lower wing the lock counter-part (8) is assembled. The grip is pushed 2 cm forward and locking of both two wings is realized when the grip is turned 90 degrees clockwise. Opening of the locked up grip system with sliding coupling is ensured by turning the grip 90 degrees counterclockwise.

The lock shaft with adjusted screw (2a) can be screwed to the grooved tube (1b) up to the sliding wide. After completion of the adjustment the fixation process is made by means of the fixation nut and thus the product is adjustable in accordance with sliding wide.

The sliding wide adjustment system used in the product is the most practical and convenient application configuration and also similar function is available with a different application.

The grooved tube (1b) representing an integration with the stick-grip (1a) and being an extension thereof has an important role for the adjustment of the product in accordance with the sliding wide and the fixation. The sliding wide is adjusted with the lock shaft with adjusted screw (2a), which passes through the grooved tube (1b). If here preferred, the fixation by means of nut could be made in replacing the grooved tube (1b) with an even tube and replacing the lock shaft with adjusted screw (2a) with an even part, and the space adjustment and fixation could be made by means of methods and apparatuses like screwing by opening of a screw hole or unification by means of a clamp, and thus the same function is executable.

The system used in the manner as given above provides a huge improvement in the insulation of dust and rain water, which may come from outside, and a huge saving in the cost for the maintenance and repair of the locking system, the total cost of the locking system and the labor power required for the assembling of the locking system is ensured.

1-6. (canceled)

7. A lockable grip system with a sliding coupling for sliding windows, comprising a locking grip apparatus, the apparatus comprising:
a stick-grip (1a) disposed at a first distal side of the apparatus;
a grooved tube (1b) abutting the stick grip;
a lock shaft with an adjustable screw (2a) housed within the grooved tube;
a lock shaft head with an adjustable screw (2b) of the lock shaft (2a) disposed at a second distal side of the apparatus;
an adjustment fixation nut (4) attached to the lock shaft with adjustable screw (2a) and fixing the lock shaft with adjustable screw (2a) with the grooved tube (1b);
a lock shaft pulling spring (5) attached to the lock shaft head with adjustable screw (2b) and abutting the adjustment fixation nut (4);
a shaft spring and a nut slot (6) housing the fixation nut (4), the spring (5) and the lock shaft (2a);
a slot cover (3) covering an end of the shaft spring and nut slot (6);
a lock head stopper (7) located next to the shaft spring and nut slot (6); and
a pulling lock counterpart (8) next to the lock head stopper (7),
wherein the lock head stopper (7) and the counterpart (8) each having an aperture through which the lock shaft head with adjustable screw (2b) is inserted.

8. A lockable grip system according to claim 7, wherein the locking grip apparatus is located between a pair of sliding wings of the sliding windows and thereby during locking, both wings are pulled against each other.

9. A lockable grip system according to claim 7, wherein the stick-grip (1a) and the pulling lock counter-part (8) in the sliding system are connected from a single point.

10. A lockable grip system according to claim 7, wherein there are no counter parts affixed to a frame of the sliding windows.

11. A lockable grip system according to claim 7, wherein the lock shaft with adjustable screw (2a) is screwed to the grooved tube (1b) up to a sliding wing such that the locking grip apparatus is utilized in a sliding system of one or more wings due to the fixation by means of the fixation nut (4).

12. A lockable grip system according to claim 7, wherein
a plurality of smooth tubes are utilized instead of the lock shaft with adjustable screw (2a) and the grooved tube (1b); and
the plurality of smooth tubes include one or more screw holes formed on the tubes wherein the tubes are screw fastened or coupled by means of a clamp.
